(19) United States
(12) Patent Application Publication
(10) Pub. No.: US 2007/0297282 A1
(43) Pub. Date: Dec. 27, 2007

(54) Electric Mixer for Modifying the Consistency of the Phase of a Confectionery Product

(76) Inventor: Walter Procuranti, Rezzato (IT)

Correspondence Address: RATNERPRESTIA, P O BOX 980, VALLEY FORGE, PA, 19482-0980, US

(21) Appl. No.: 11/665,629

(22) PCT Filed: Oct. 14, 2005
(86) PCT No.: PCT/IT05/00602

§ 371 Date: Apr. 17, 2007

(30) Foreign Application Priority Data
Oct. 22, 2004 (IT) MI2004A002016

(51) Int. Cl. A47J 43/04

(52) U.S. Cl. 366/255; 426/504

(57) ABSTRACT

An electric mixer to modify the consistency of the phase of a confectionery product, includes a container for the product, a member closing the container and a tool for working the product which are in line with each other and a movement device capable of moving the container. The movement device includes a first reversible movement of the open container with respect to the closing member between an initial position in which the container is open and a final position in which the container is closed, and a second reversible movement of the closed container with respect to the tool between an initial position of minimum penetration of the tool into the container and a final position of maximum penetration of the tool into the container.

### TECHNICAL FIELD

This invention relates to an electric mixer for modifying the consistency of the phase of a confectionery product, in particular an electric mixer for professional and domestic use which is capable of effecting the rapid preparation of mousses, creams, whipped cream, ice cream and the like from prepacked quantities.

### STATE OF THE ART

There are today examples of professional electrical equipment capable of preparing multiple quantities of ice-cream from packs of ingredients or mixtures of ingredients already provided and frozen in suitable metal containers.

In general these comprise an ice-cream container located in a physical support and a tool for working the ice-cream driven by a rotational/translational motor capable of abrading the surface of the frozen product, gradually varying the depth of penetration within the container.

These are costly and bulky devices, which are not very easy to use.

In particular the rotational/translational movement mechanism for the tool is complex.

In addition to this the position and shape of the physical support for the container is particularly inconvenient when it is necessary to gain access to it to fit and remove the container, and also for inspection and/or cleaning.

### DESCRIPTION OF THE INVENTION

The technical task which this invention is designed to perform is therefore that of providing an electric mixer and a process for the rapid preparation of mousses, creams, whipped cream, ice-cream and the like starting with prepacked quantities, which makes it possible to overcome the technical disadvantages complained of in the known art.

In the context of this technical task one object of the invention is to provide an electric mixer for the rapid preparation of mousses, creams, whipped cream, ice cream and the like from prepacked quantities, which is of low cost and has small dimensions, is simple in operation and is easy to use.

Another object of the invention is to provide an electric mixer for the rapid preparation of mousses, creams, whipped cream, ice-cream and the like from prepacked quantities, which provides easy access to the internal components, in particular to the container and container support, to ease fitting and removal of the container, inspection and/or cleaning.

According to the invention, the technical task, as well as these and other objects, is accomplished through the provision of electric mixer for modifying the consistency of the phase of a confectionery product, characterised in that it comprises a container for the said product, a member closing the said container and a tool for working the said product which are in line with each other, and means capable of effecting movement of the said container comprising a first reversible movement of the said open container with respect to the said closure member between an initial open position of the said container and a final closed position of the said container, and a second reversible movement of the said closed container with respect to the said tool between an initial position In which there is minimum penetration of the said tool into the said container and a final position in which there is maximum penetration of the said tool into the said container.

This invention also relates to a process for modifying the consistency of the phase of a confectionery product through an electric mixer, characterised in that it comprises at least carrying out a first forward movement of a container of the said product with respect to the said closure member for the said container from an initial open position of the said container to a final closed position of the said container and once the said final closed position of the said container has been reached driving a tool for working the said product within the said closed container in rotation, delivering pressurised air within the said closed container to emulsify the said product, and performing a second movement of the said closed container with respect to the said tool to increase the depth of penetration of the said tool within the said container.

Other features of this invention are also defined in the subsequent claims.

### BRIEF DESCRIPTION OF THE DRAWINGS

Other advantages and characteristics of the present invention will become clear from the following detailed description which is given with reference to the appended drawings which are provided purely by way of non-limiting example and in which:

FIG. 1 shows a perspective view of a preferred embodiment of an electric mixer according to the invention in which the enclosure is partly removed, with the container in the open reference position,

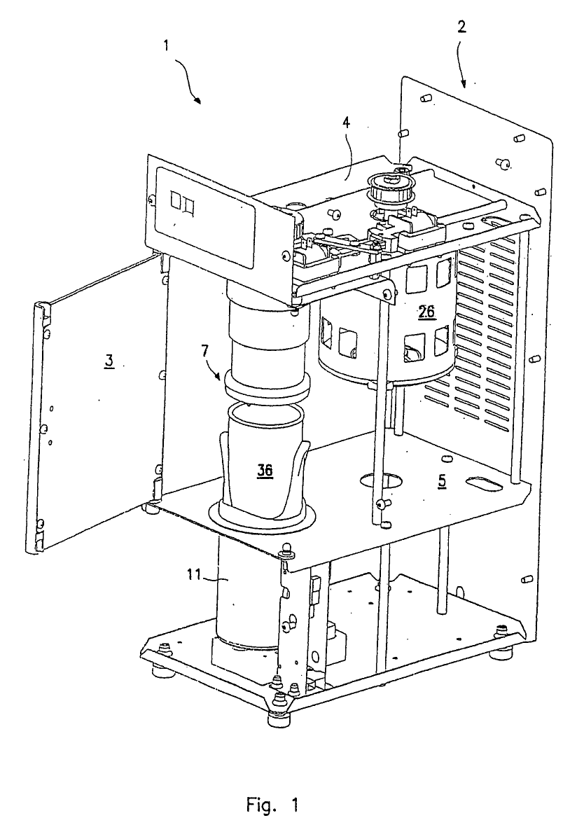

FIG. 2 provides a view in axial cross-section of the electric mixer in FIG. 1, with the container in the open reference position,

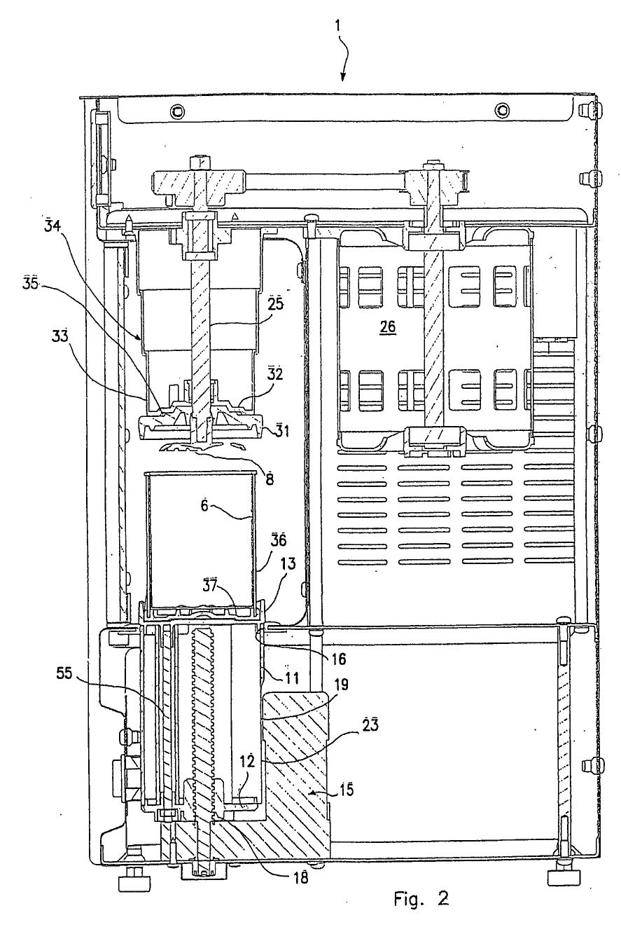

FIG. 3 shows a view in axial cross-section of the electric mixer in FIG. 1, with the container closed in a position adopted during the second movement with respect to the tool,

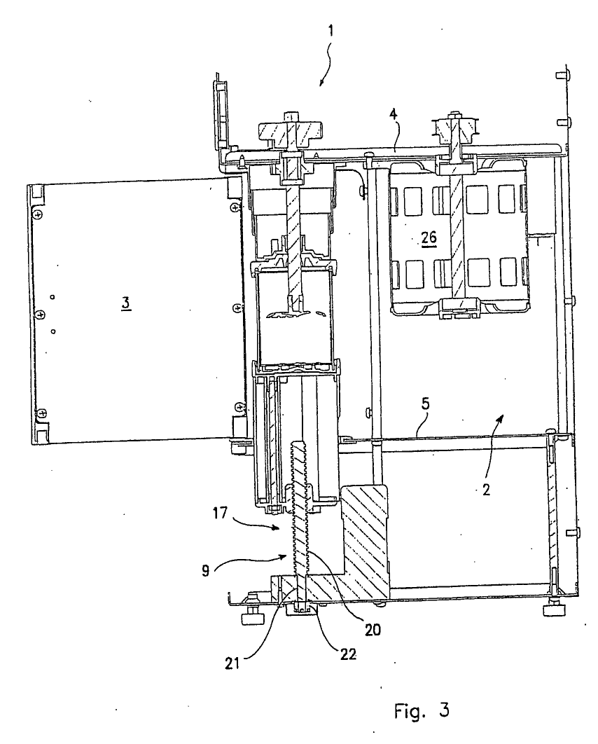

FIG. 4 shows a plan view of the electric mixer in FIG. 1 from above.

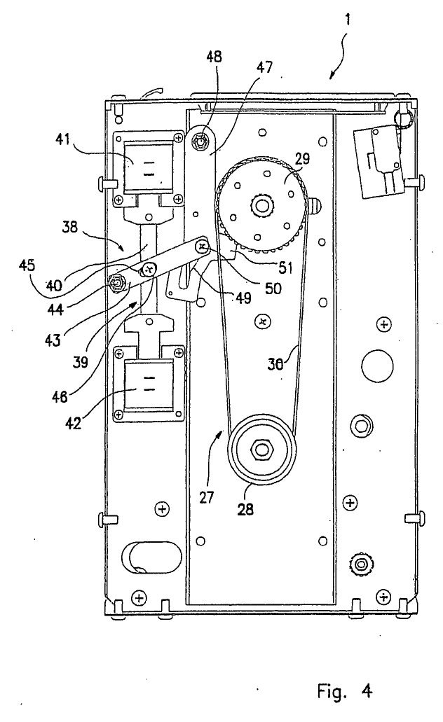

### PREFERRED EMBODIMENT OF THE INVENTION

The reference to the figures mentioned there is shown an electric mixer, indicated as a whole by reference number 1, which is capable of modifying the consistency of the phase of a confectionery product, in particular which is suitable for aiding the rapid preparation of mousses, creams, whipped cream, ice-cream and the like from prepacked quantities.

Mixer 1 comprises a tower unit comprising a box-like enclosure 2, illustrated only in part, which has at least one access door 3 to the interior of mixer 1 and one or more transverse supporting plates, in particular a plate 4 in the upper part of the space bounded by box-like enclosure 2 and a plate 5 in the bottom part of the space bounded by box-like enclosure 2.

Within box-like enclosure 2 there is a container 6 for the product being worked, in line with a closure member 7 for container 6 and a tool 8 for working the product.

In the following we will make reference purely by way of example to an electric mixer for the preparation of ice-cream from a packed and frozen quantity in which tool 8 for working the packed and frozen quantity is a mill. In particular container 6, closure member 7 and tool 8 are in line with respect to a vertical axis.

Container 6 can be moved with respect to both closure member 7 and tool 8, closure member 7 can be moved as one piece with container 6 when it is engaged therewith, while tool 8 is fixed with respect to the movement of open and closed container 6.

Movement means 9 effect movement of container 6 comprising a first reversible movement of open container 6 with respect to closure member 7 between an initial open position of container 6 and a final closed position of container 6, and a second reversible movement of closed container 6 with respect to tool 8 between an initial position of minimum penetration of tool 8 into container 6 and a final position of maximum penetration of tool 8 into container 6.

The start point for the first movement corresponds to the lowest level adopted by container 6, the end point of the first movement coincides with the start point of the second movement and corresponds to an intermediate level adopted by container 6, and the end point of the second movement corresponds to the highest level adopted by container 6.

Container 6 is borne by a hollow support 11 having a lower base 12 engaging movement means 9 from which it receives movement, and an upper base 13 supporting container 6.

Lower base 12 and upper base 13 are secured to hollow support 11 through a connecting rod 55 which runs within hollow support 11 itself.

More specifically container 6 is housed within a container holder 36 in such a way as to be joined thereto and having lower base 37 connected in a removable way, for example through a bayonet attachment system, to upper base 13 of hollow support 11.

Electric mixer 1 therefore has means to oppose relative rotation between container 6 and corresponding container holder 36 comprising matched members which can be mutually engaged between the lower base of container 6 and the lower base of container holder 36.

Preferably container 6 is of plastics while container holder 36 is of mechanically stronger material, for example steel, which is also preferable for hygiene reasons and for the greater protection offered if tool 8 should break.

Hollow support 11, which is borne by an “L-shaped” rod 15 attached to the lower base of enclosure 2 extends vertically within the space bounded between the lower base of enclosure 2 and transverse supporting plate 5, and extends through a second base 13 into the space bounded between transverse supporting plates 4 and 5 through a guide hole 16 passing through transverse supporting plate 5.

Movement means 9 comprise an endless screw 17 threaded into a threaded hub 18 of first base 12 of hollow support 11, and an intersecting member 19 which is capable of immobilising the rotation of hollow support 11 as endless screw 17 rotates.

Shank 20 of endless screw 17 is located in a hole 21 which passes from the horizontal wall of rod 15 and extends vertically within hollow body 11, while head 22 of endless screw 17 which is positioned against the outer surface of the horizontal wall of rod 15 is caused to rotate through a suitable motor (not shown) through a suitable transmission (also not shown).

The motor of the drive means is for example a variable speed direct current motor.

Intercepting member 19 is a projection in the vertical wall of rod 15 which can move in a vertical groove 23 in the side wall of hollow support 11.

Closure member 7 for container 6 is movably wedged on rotating shaft 25 supporting tool 8.

In particular shaft 25 of tool 8 is suspended vertically with respect to transverse supporting plate 4 and extends within the space bounded between plates 4 and 5 above and in line with the axis of container 6.

Shaft 25 of tool 8 is caused to rotate by a motor 26 through a movement transmission 27.

Motor 26 is also suspended on transverse supporting plate 4 and is positioned with its shaft vertical in the space bounded by plates 4 and 5, while transmission 27 is wholly positioned above supporting plate 4.

Transmission 37 has a guide pulley 28 wedged on motor shaft 26, a driven pulley 29 wedged on shaft 25 of tool 8 and a transmission belt 30 which connects drive pulley 28 to driven pulley 29.

Motor 26 for tool 8 may for example be of the alternating current constant speed type.

Closure member 7 has a resilient portion 31 facing container 6 so as to provide a seal when the container is closed, and a rigid portion 32 associated with resilient portion 31.

Rigid portion 32 is borne by a terminal member 33 of telescopic protection tube 34 supported by plate 4 and containing within it shaft 25. Tubular protection 34 may be replaced by an equivalent member, such as a bellows or the like.

The mixture has delivery means 10 capable of delivering pressurised outside air into closed container 6.

Delivery means 10 comprise a delivery duct 35, bounded between the opposing associated surfaces of resilient and rigid portions 31 and 32, in communication with the interior of container 6 through one or more passages (not shown) made through resilient portion 31.

Air at a pressure of between approximately 1 bar and 2 bars is fed from an electrically-operated pump (not shown) connected to the mixer's control unit.

Electric mixer 1 comprises means (not shown) for detecting the start and end positions of the first and second movements of container 6.

The detection means positioned along the path of container-hollow support unit 11 are connected to the mixer's control unit and comprise a first microswitch detecting the start position of the first movement of the open container, a second microswitch detecting the end position of the first movement coinciding with the start position of the second movement of the closed container, and a third microswitch detecting the end position of the second movement.

Electric mixer 1 also has electromechanical means 38 for immobilising the rotation of tool 8, which are useful when it is necessary to remove tool 8.

Means 38 immobilising the rotation of tool 8 comprises a lever mechanism 39 mounted on the outside of transverse plate 4.

Lever mechanism 39 has a first lever 40 connected to two solenoids 41 and 42 connected to the control unit and capable of imparting a first reversible movement to first lever 40, a second lever 43 pivoted on plate 4 at 44 and having an eyelet 45 which receives a pin 46 which is integral with first lever 40 and is capable of converting movement of first lever 40 into rotation of second lever 43, and a third lever 47 pivoted on plate 4 at 48 and having an eyelet 49 which receives a pin 50 which is integral with second lever 43 and capable of converting rotation of second lever 43 into rotation of third lever 47.

Third lever 47 has an appendage 51 which when third lever 47 rotates moves from a position which is tight upon the drive pulley wedged to the shaft of tool 8 to a release position, and vice versa.

To assist tightening, the drive pulley wedged on shaft of tool 8 has peripheral shapes in which appendage 51 engages.

A switch comprising for example at least an on/off switch for the mixer, a commutating switch for the first microswitch to start a production cycle, a switch stopping the production cycle and zeroing the production cycle and a switch for rapidly effecting a production cycle are attached to the mixer's control unit.

The safety system (not shown) for the mixer comprises a detector which detects the presence of container 6 connected to the control unit to control the output of an alarm signal if container 6 is not detected when the start of a production cycle Is enabled, an open holder detector connected to the control unit to control the output of an alarm signal if the holder is found to be open when the start of a production cycle is enabled, and a limiting force detector for the motor for the movement means and/or tool arising from the resistance offered to the tool by the product and based for example on detecting the motor's power consumption, which is also connected to the control unit to control reversal of the production cycle and the output of an alarm signal if the limiting force is exceeded.

The process for modifying the consistency of the phase of the confectionery product through the electric mixer according to this invention consists of performing an outward movement followed continuously by a reverse return movement of container 6.

In the starting outward movement the first movement of container 6 is performed and when container 6 reaches its final closure position tool 8 is driven in rotation to work the product, pressurised air is delivered into closed container 6 to emulsify the product, and the second movement of closed container 6 with respect to tool 8 is performed to increase the penetration depth of tool 8 within container 6.

During the return movement a first reverse return movement of the second outward movement is performed to decrease the depth to which tool 8 penetrates container 6, at the end of which the rotation of tool 8 is switched off and pressurised air is delivered into container 6, and the second return movement opposite to the first outward movement is performed to open container 6.

The second outward and return movement is carried out at the same or slower speed than that of the first outward movement in each case.

In the same way the first return movement is carried out at the same or slower speed than that of the second return movement.

When for cleaning or replacement needs it is necessary to remove tool 8, which is preferably connected to the corresponding rotation shaft through a screw connection, the means for immobilising the rotation shaft of tool 8 are activated and tool 8 is engaged with an accessory of matching shape.

Rotation of the accessory causes tool 8 to rotate and become unscrewed from the corresponding rotation shaft, the latter being immobilised with respect to rotation.

An example of the manner of operation of the mixer according to the invention is in detail substantially as follows.

After container 6 (of the disposable type) has been placed in container holder 36 and the latter has been placed on hollow support 11, the switch is activated to start the production cycle.

In response to the signal for starting up the production cycle the control unit switches the first microswitch, switching on the motor for movement means 9.

The unit of container 6/container holder 36/hollow support 11 rises, performing a first movement to a position in which it meets the resilient position 31 of closure member 7 which seals it.

The speed of this first outward movement is the maximum permitted. In this position the unit of container 6/container holder 36/hollow support 11 intercepts the second microswitch switching it in such a way that this commands start-up of both the motor of mill 8 and the electrical pump delivering air.

The unit of container 6/container holder 36/hollow support 11 rises again performing a second movement at a speed of 25% of that of the first outward movement.

The second outward movement continues until the group intercepts the third microswitch, switching it in such a way that the latter causes the movement of container 6 to be reversed.

The unit of container 6/container holder 36/hollow support 11 sinks carrying out a first return movement opposite to the second movement. The unit again intercepts the second microswitch, again switching it in such a way that the latter causes the motor of drill 8 and the electrically-operated pump delivering air to stop.

In this situation the mill is advantageously only in movement when the container is sealed.

The units of container 6/container holder 36/hollow support 11 sinks again performing a second return movement opposite to the first movement.

The unit intercepts the first microswitch in such a way that this causes the motor of movement means 8 to stop.

The speed of reverse movement is approximately 50% of the maximum permitted speed.

In the reverse movement the closure member removes any parts of the product which might have remained adhering to it during the production cycle by moving along the shaft of the mill.

The electric mixer so envisaged may be subjected to numerous modifications and variants, all falling within the scope of the inventive concept; in addition to this all details may be replaced by technically equivalent members.

In practice the materials used and the dimensions may be of any kind according to requirements in the state of the art.

1.) An electric mixer for modifying the consistency of the phase of a confectionery product, comprising a container for the product, a member for closing the container and a tool for working the product, and movement means capable of causing the container to move in a first reversible movement between an initial position in which the container is open with respect to the closing member and a final position in which the container is closed with respect to the closing member, and a second reversible movement of the closed container with respect to the tool between an initial position of minimum penetration of the tool into the container and a final position of maximum penetration of the said tool into the container.

2.) The electric mixer according to claim 1, wherein the container, the tool and the closing member are vertically aligned.

3.) The electric mixer according to claim 1, wherein a start point for the first movement corresponds to the lowest position adopted by the container, an end point for the first movement coincides with the start point of the second movement and corresponds to an intermediate level adopted by the container, and the end point of the second movement corresponds to the highest level adopted by the container.

4.) The electric mixer according to claim 1, wherein the closing member is slidably keyed onto a rotating shaft supporting the tool.

5.) The electric mixer according to claim 1, wherein the closing member has a resilient portion facing the container which is capable of forming a seal when the container is closed.

6.) The electric mixer according to claim 5, further comprising delivery means for delivering pressurized outside air into the closed container.

7.) The electric mixer according to claim 6, wherein the closing member has a rigid portion associated with the resilient portion, the delivery means comprising a delivery duct bounded between the opposing associated surfaces of the resilient and rigid portions in communication with an interior of the container through one or more passages made through the resilient portion.

8.) The electric mixer according to claim 1, wherein the container is supported by a hollow support having a lower base engaging the movement means from which it receives movement, and an upper base supporting the container.

9.) The electric mixer according to claim 8, wherein the container is housed within a container holder of matching shape and having a lower base movably connected to the upper base of the hollow support.

10.) The electric mixer according to claim 9, further comprising means to prevent relative rotation between the container and the container holder comprising elements of matching shape which engage with each other.

11.) The electric mixer according to claim 8, wherein the movement means comprise a rotatable endless screw which screws into a threaded hub in the lower base of the hollow support and an intercepting member capable of immobilising rotation of the hollow support during rotation of the endless screw.

12.) The electric mixer according to claim 4, further comprising a tower unit having at least one transverse plate on which the motor driving the tool and the sad rotation shaft of the tool are suspended.

13.) The electric mixer according to claim 12, wherein the transverse plate supports a mechanism on the side opposite the motor and the rotation shaft of the tool to transmit motion from the motor to the rotation shaft of the tool.

14.) The electric mixer according to claim 1, further comprising electromechanical means for immobilizing rotation of the said tool.

15.) The electric mixer according to claim 12, wherein the means for immobilizing rotation of the tool comprise a lever mechanism supported on the transverse plate opposite to the motor and the rotation shaft of the tool, and operating directly on the pulley for transmitting movement to the rotation shaft of the tool.

16.) The electric mixer according to claim 3, further comprising a detector means for detecting the start and end points of the first and second movements

17.) The electric mixer according to claim 16, wherein the detector means is connected to a control unit and comprises a first microswitch detecting the start point of the first movement, a second microswitch detecting the end point of the first movement coinciding with the start point of the second movement, and a third microswitch detecting the end point of the second movement.

18.) A procedure for modifying the consistency of the phase of a confectionery product by an electric mixer, the procedure comprises the steps of at least performing a first outward movement of a container for the product with respect to a member, moving the container from an initial position in which the container is open to a final position in which the container is closed, activating in rotation a tool for working the product within the closed container, delivering pressurized air into the closed container to emulsify the product, and performing a second movement of the closed container with respect to the tool to increase the depth of penetration of the tool into the said container.

19.) The procedure according to claim 18, further comprising carrying out, after the second movement, a first return movement opposite to the second movement to decrease the depth of penetration of the tool in the container, at the end of the first return movement deactivating both rotation of the tool and delivery of pressurized air within the container, and performing a second return movement opposite to the first outward movement to open the container.

20.) The procedure according to claim 19, wherein the first and second outward and return movements are carried out one after the other without interruption.

21.) The procedure according to claim 19, wherein the second outward movement is performed at a speed which is less than or equal to that of the first outward movement.

22.) The procedure according to claim 19, wherein the first return movement is carried out at a speed which is less than or equal to that of the second return movement.

23.) The process according to claim 18, wherein the tool is mechanically immobilized for removal of the tool through an accessory having a shape matching the tool which engages with it to remove it through unscrewing.
